(19) United States
(12) Patent Application Publication
(10) Pub. No.: US 2016/0111013 A1
(43) Pub. Date: Apr. 21, 2016

(54) LEARNING CONTENT MANAGEMENT METHODS FOR GENERATING OPTIMAL TEST CONTENT

(71) Applicant: Cornell University, Ithaca, NY (US)

(72) Inventors: Igor Labutov, Ithaca, NY (US); Hod Lipson, Ithaca, NY (US); Kelvin Luu, Ithaca, NY (US)

(21) Appl. No.: 14/884,704

(22) Filed: Oct. 15, 2015

Related U.S. Application Data
(60) Provisional application No. 62/064,288, filed on Oct. 15, 2014.

(51) Int. Cl. G09B 7/06

(52) U.S. Cl. CPC G09B 7/06

(57) ABSTRACT

Competency of a participant is based on the probability of a participant selecting a particular answer is a function of that participant's ability (or ranking) and the correctness of the answer (either presented to or created by the participant). The participant's competency—or level of understanding of the content—is used to generate optimal test content.

### CROSS-REFERENCE TO RELATED APPLICATIONS

This application claims the benefit of U.S. Provisional Patent Application No. 62/064,288 filed Oct. 15, 2014, incorporated by reference.

### FIELD OF THE INVENTION

The invention relates generally to computer system methods directed to large scale on-line education to one or more participants. More specifically, the invention is directed to methods for assessing competency of a participant based on both content presented to, or created by the participant during an on-line test and a ranking of the participant. The competency assessment is used to generate optimal test content.

### BACKGROUND OF THE INVENTION

Educational technology is the effective use of technological tools in learning concerning an array of tools, such as media, machines and networking hardware, as well as considering underlying theoretical perspectives for their effective application.

E-learning, also called on-line education, uses educational technology including, for example, numerous types of media that deliver text, audio, images, animation, and streaming video, and includes technology applications and processes such as audio or video tape, satellite TV, CD-ROM, and computer-based learning, as well as local intranet/extranet and web-based learning. Information and communication systems, whether free-standing or based on either local networks or the Internet in networked learning, underlie many e-learning processes including methods for assessing participants, methods for generating tests, etc.

E-learning can occur in or out of the classroom and typically use one or more learning content management systems (LCMS), which include software technology providing a multi-user environment that facilitates the creation, storage, reuse, and delivery of content. E-learning can be self-paced, asynchronous learning or may be instructor-led, synchronous learning. It can also be suited to distance learning or in conjunction with face-to-face teaching.

Computer-aided assessment ranges from automated multiple-choice tests to more sophisticated systems. With some systems, feedback can be geared towards a user's specific mistakes or the computer can navigate the user through a series of questions adapting to what the user appears to have learned or not learned.

With the growing interest in large scale on-line education, fueled in part by the recent emergence of MOOCs (Massively Open Online Courses), comes an important problem of assessing competency of (typically many) learners.

While the transmission of teaching material has benefited significantly from the digital medium, assessment methodology has changed little from an age-old tradition of instructor generated and instructor-graded tests. While grading plays an integral role in any form of assessment, the generation of assessment material itself, i.e. tests, presents an equally important challenge for addressing the scaling of assessment methods.

In addition, technical documentation, for example, in the form of heterogeneous on-line tutorials, e-books, lecture notes, video lectures are growing on the web, and play an increasing role as both supplemental and primary sources in personalized, individual learning. Unfortunately few of these sources come with assessment material. If available, assessment quizzes, would allow the learner to self-reflect on the areas in which he or she is lacking, and help provide feedback to guide the learner towards additional material. An assessment mechanism would also facilitate ranking of the learners on their depth of understanding of the material, similar to the “top-scorer” list in a video game. In addition to assessment of the participant, creation of test content based on the assessment remains difficult. For example, a finite set of alternatives for a learner to pick from—the key feature of a MCQ that makes it attractive in grading—is the very thing that makes good MCQs notoriously difficult to create.

Therefore, there is a need for an effective fully autonomous method for assessing participant competency for use in generating optimal test content.

### SUMMARY OF THE INVENTION

The invention relates generally to computer system methods directed to large scale on-line education to one or more participants. For purposes of this application, “participant” is also referred to as “learner” and “user”.

According to the invention, competency of a participant is used to generate optimal test content. Competency is the participant's level of understanding of the content. A participant's competency is a measure of the probability of a participant selecting a particular answer is a function of that participant's ability (or ranking) and the correctness of the answer (either presented to or created by the participant). More specifically, the invention provides optimal test content determined by the participant's level of understanding of the content.

An advantage of the invention is that a participant fills the roles of both a user and a teacher, under complete autonomy. Unique parameters are used to capture intrinsic ability of the learner—ranking—and the quality and difficulty of the question. These parameters are values used to generate test content—in the form of a quiz for the participant that effectively satisfies the participant's ranking. Test content may refer to question(s) and answer(s) including, for example, a multiple choice question (MCQ) that includes a plurality of answers, a free-form question that requires the user to enter an answer, or true-false questions and matching questions, to name a few. For purposes of this application, an “answer” may also be referred to as an “option”.

Ranking a participant employs a probabilistic model, but incorporates the dynamic process of question generation and allocation in a principled manner. Additionally, the invention directly obtains a global ranking of the learners. For example, a large database of learner-generated questions means that no two learners are likely to take the same exact test (same set of questions). Although this may provide no meaningful interpretation to individual test scores, it still provides a valid global ranking of learners.

The quality and difficulty of a question can be controlled through its answers, for example in a MCQ. For example, an otherwise difficult question can be made easy by providing a set of answer options of which most are incorrect options, otherwise known as “distracters”. According to the invention, a data-driven approach is used to assemble correct and incorrect options directly from users' own past submissions.

Ideally distracters are picked from a representative set of misconceptions that learners commonly share. But even if this set is representative, the question might still fail to distinguish between users who were “close” to the correct answer, and those who were clueless.

Similar to known adaptive testing, the invention selects questions at a level appropriate for the user, such that their responses result in the most accurate estimate of their knowledge. This is achieved by designing a single question via selecting a set of options to present as potential answers. Selecting potential answers is inherently a batch optimization problem in that all potential answers must be considered jointly during optimization in contrast to question selection, which assumes independence between questions and finds the optimal set in a greedy fashion.

The invention proposes a way to leverage the massive number of user submissions and answer click-through logs to generate rich, adaptive and data-driven questions that exploit actual user misconceptions.

According to the invention, a probability of a user choosing a particular option as a function of that user's ability and that option's correctness is determined, such that more able users are more likely to the pick the most correct option. An “ideal” user (with the greatest attainable ability) chooses the correct option with probability 1. A user with the least attainable ability makes their choice uniformly at random. Therefore, with a non-negativity constraint, the user's ability lies on a continuum ranging from 0 to 1.

A MCQ with one correct option leaves the remaining options as distractors, each with a correctness parameter value that lies on a continuum such that a more able user is more likely to discern the correct option. For example, distractors may be chosen far from the correct answer if the user ability parameter is low.

The invention improves upon learning content management systems (LCMS) by providing a database compartmentalized into separate databases, one each for questions, answers, and user rank or ability. The database is used to provide an improved method for generating optimal test content, for example, a MCQ with four (4) potential answers.

The invention contemplates a joint framework for crowdsourcing both the assessment content (in the form of a quiz), and the assessment (in the form of ranking) of the participants. Crowdsourcing represents the act of using an undefined (and generally large) network of people in the form of an open call.

According to one embodiment, forums such as that known as Stack Exchange™—a network of question and answer websites on topics in varied fields—may be used to rank participants. For example, “upvote” scores—how users show appreciation and approval of a good answer to a question—may be used such that a user that receives a significantly greater number of upvotes than another user for the same post is informative of a higher rank. Similarly, a user who is able to answer another user's question is likely to be ranked higher.

One embodiment of the invention may incorporate a network of question and answer websites to generate new assessment content. Various signals may be used that indicate quality of answers and questions appearing on the websites. For example, signals may include indicators of users' activity on a technical forum, such as the total number of upvotes or downvotes given to a particular answer, whether or not answer has been accepted by the asker, etc. These signals can all be used according to the invention to generate new assessment content (e.g. in the form of questions) by recombining answers and questions in a way that make the resulting test efficient informative on the ability of new users.

The invention and its attributes and advantages may be further understood and appreciated with reference to the detailed description below of one contemplated embodiment, taken in conjunction with the accompanying drawings.

### BRIEF DESCRIPTION OF THE DRAWINGS

The preferred embodiments of the invention will be described in conjunction with the appended drawings provided to illustrate and not to limit the invention, where like designations denote like elements, and in which:

FIG. 1 illustrates a block diagram of a learning content management system database.

FIG. 2 illustrates a flow chart of a method for generating optimal test content.

FIG. 3 illustrates a flow chart of a method for selecting test content.

FIG. 4 illustrates an exemplary computer system that may be used to implement the invention including a learning content management system database.

FIG. 5A illustrates one embodiment of a user interface display.

FIG. 5B illustrates another embodiment of a user interface display.

FIG. 6 illustrates another embodiment of a user interface display.

FIG. 7 illustrates another embodiment of a user interface display.

FIG. 8 illustrates another embodiment of a user interface display.

### DETAILED DESCRIPTION OF EMBODIMENTS OF THE INVENTION

Competency of a participant is based on the probability of a participant selecting a particular answer is a function of that participant's ability (or ranking) and the correctness of the answer (either presented to or created by the participant). The participant's competency is used to generate optimal test content selected from a database including questions, answers, and participant ranking.

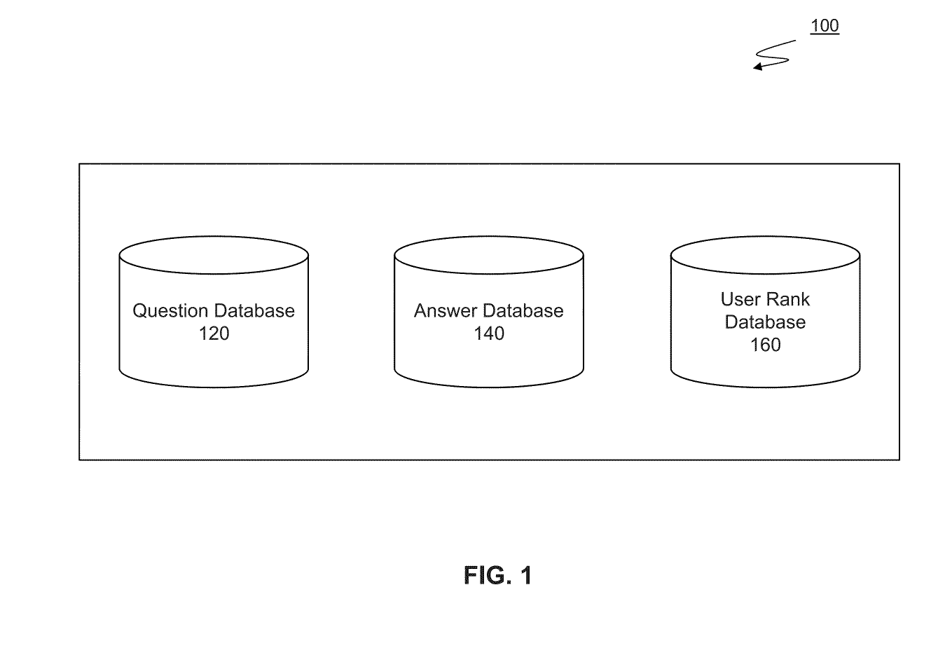

FIG. 1 illustrates a block diagram of a learning content management system database 100. Database 100 is compartmentalized into a question database 120, answer database 140, and user rank database 160.

Question database 120 includes questions Q with a difficulty rating of qⱼ. Questions may be predetermined or created by a user during a quiz. Questions created by the user are contributed to the question database. Question database 120 may also include questions formulated according to the potential answers chosen as test content based on the user's ability

Answer database 140 includes answers {βⱼ}_{j∈Q} for each question Q. Each answer has an assigned correctness parameter. It is also contemplated that the assigned correctness parameter of an answer may change based on its quality or difficulty with respect to the question such that the database 140 must be continuously updated. The assigned correctness parameter of an answer may also be updated in the database 140 when changed based on the ability of the user that submitted the answer. Similar to questions, answers may be predetermined or created by a user during a quiz. Answers created by the user are contributed to the answer database.

User rank database 160 includes learners sᵢ each with an assigned ability parameter θᵢ. User rank database 160 may be updated based on any changes to the user ability parameter value. The ability parameter value defines a ranking of the user and used in choosing test content.

According to the invention, users provide answers proportional to their ability. Specifically, a user's selection is made proportional to the ability of the user and correctness of the choice, such that more able users are more likely to discern the correct choice from incorrect choices. This is based on the premise that easier questions are likely to receive more correct answers. According to certain embodiments of the invention, a user selects any number of correct answers, including an option to select “none of the above” as a response allowing the user to provide a user-generated answer (which may result in multiple contributed answers that are correct).

The invention provides a partial order constraint on choices and a non-negativity constraint on the user ability:

$$P ( {s}_{i} picks option j \vert {θ}_{i} , {\{ {β}_{j} \}}_{j ∈ Q} ) = \frac{exp ( {θ}_{i} {β}_{j} )}{{\sum }_{{β}_{{j}^{′}} ∈ Q} exp ( {θ}_{i} {β}_{{j}^{′}} )} \\ such that {β}_{j *} > {β}_{j} ∀ {β}_{j} ∈ Q ∖ {β}_{j *} \\ {θ}_{i} \geq 0 ∀ i$$

where sᵢ is user i with ability θᵢ, and {βⱼ}_{j∈Q} is the set of option parameters of question Q with encoding the apparent correctness of each option and βⱼ* is the correct option. The non-negativity constraints on the θᵢ, combined with the partial order constraints on the option parameters are critical to obtain the desired interpretation of the θᵢ parameters, namely as capturing the ability of the user. Therefore, a user's answer selection is made proportional to the ability of the user (ability parameter) and correctness of the choice (correctness parameter).

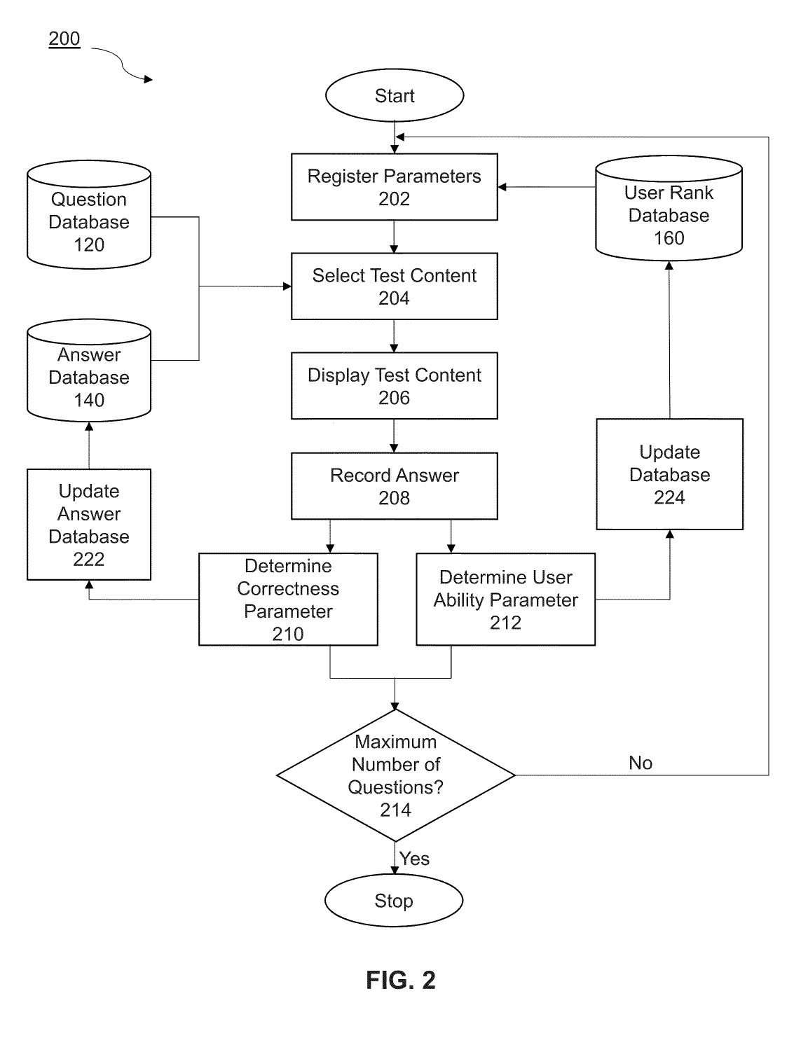

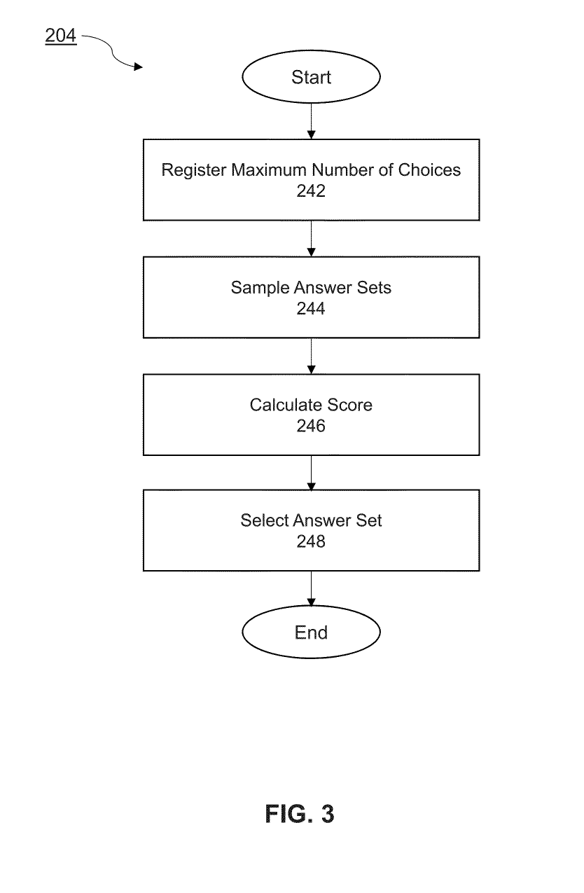

FIG. 2 illustrates a flow chart of a method for generating optimal test content. At step 202, parameter values are registered that specify a probability of a user choosing a particular option as a function of that user's ability. Once the parameter values are registered, test content is selected at step 204. Additional details regarding the selection of test content at step 204 from both the question database 120 and answer database 140 is discussed more fully in reference to FIG. 3.

Test content is displayed at step 206 and an answer or option is recorded at step 208. Again, the answer may be selected from a predetermined set or created by a user and contributed to the question database.

The answer is analyzed in order to determine and assign a correctness parameter value shown at step 210 and a user ability parameter value shown at step 212. Each parameter value lies on a continuum. As an example, a user ability parameter lies on a continuum ranging from 0 to 1. A correctness parameter of each answer choice and the relation of the correctness parameter between each other implicitly encodes the difficulty of the question, and the user ability parameter captures the intrinsic ability of the learner, i.e., ranking.

In addition to each answer, which may be interpreted as the “obviousness of correctness”—a larger negative value corresponds to “more obviously wrong”, and a more positive value corresponds to “more obviously correct”—, the difficulty of the question qⱼ is embedded on the same scale.

The correctness parameter value determined at step 210 is used to update the user rank database 160 at step 224. The user ability parameter value determined at step 212 is used to update the user rank database 160 at step 224.

At step 214, a determination is made if a maximum number of questions have been reached. If so, the process is complete. If a maximum number of questions have not been reached, the process repeats with the updated parameter values, including the user ability parameter value.

According to one embodiment of the invention, the above equation is applied to the data gathered from user interactions with questions in form of <USER A chose OPTION B of QUESTION X>. This type of data from many users and questions is used by the invention to assign correctness parameter values of each choice and ability value to each user. As an example, this may be accomplished by maximizing the probability of all observations via Least Squares Programming algorithms (SQLP). As another example, this may be accomplished via a Bayesian inference, for example Variational Message Passing (VMP). VMP provides a general method for performing variational inference in conjugate-exponential models by passing sufficient statistics of the variables to the neighbors, which are used in turn to update their natural parameters.

Once the correctness parameters for each choice are known and the individual ability or aggregate ability of participants is known—estimated or hypothesized—a scoring function can be applied directly to each possible combination of answer choices according to:

$${maximize}_{\{ {x}_{i} {x}_{j} \}} \frac{{\sum }_{i , j} {x}_{i} {{x}_{j} ( {β}_{i} - {β}_{j} )}^{2} exp ( θ [ {β}_{i} + {β}_{j} ] )}{{\sum }_{i , j} {x}_{i} {x}_{j} exp ( θ [ {β}_{i} + {β}_{j} ] )}$$

$$subject to$$

$${x}_{i} ∈ \{ 0 , 1 \} , ∀ {x}_{i}$$

$$\sum {x}_{i} \leq K$$

where xᵢ and xⱼ are selection variables, θ is ability of the participant, β is the correctness parameter of each choice, and K is the maximum number of choices for a question Q. The answer choices with the maximum quantity specified by the above formula are selected to be shown to the user.

More specifically, FIG. 3 illustrates a flow chart of a method for selecting test content as shown by step 204 of FIG. 2. Test content is selected from both the question database 120 and answer database 140 based on the user ability parameter value and the correctness parameter value. At step 242, the maximum number of choices K for a question Q is registered. As an example, K equals four (4) such that each question Q has an answer set comprising four (4) or less potential choices. The answer database is queried and answer sets are sampled at step 244. It is contemplated that any sampling strategy may be employed. For example, a random sampling strategy uniformly queries answers from the database at random. As another example, an optimal sampling strategy may query answers from the database according to a participant's true ability. It is also contemplated that an optimal sampling strategy may query answers from the answer database according to a participant population such as the mean ability of the population. At step 246 each sample set is scored according to the scoring function above. The answer set with the greatest score is selected at step 248.

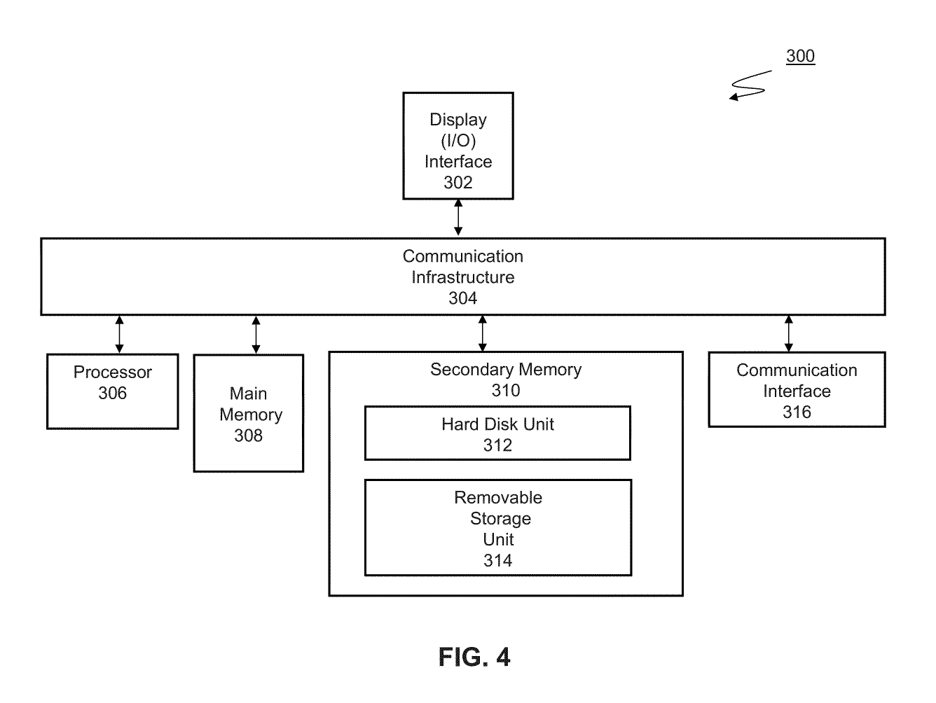

FIG. 4 illustrates an exemplary computer system 300 that may be used to implement the invention including a learning content management system database. Computer system 300 includes an input/output interface 302 connected to communication infrastructure 304—such as a bus—, which forwards data such as graphics, text, and information, from the communication infrastructure 304 or from a frame buffer (not shown) to other components of the computer system 300. The input/output interface 302 may be, for example, a display device, a keyboard, touch screen, joystick, trackball, mouse, monitor, speaker, printer, Google Glass® unit, web camera, any other computer peripheral device, or any combination thereof, capable of entering and/or viewing data.

Computer system 300 includes one or more processors 306, which may he a special purpose or a general-purpose digital signal processor configured to process certain information. Computer system 300 also includes a main memory 308, for example random access memory (RAM), read-only memory (ROM), mass storage device, or any combination thereof. Computer system 300 may also include a secondary memory 310 such as a hard disk unit 312, a removable storage unit 314, or any combination thereof. Computer system 300 may also include a communication interface 316, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that the main memory 308, secondary memory 310, communication interface 316, or a combination thereof, function as a computer usable storage medium, otherwise referred to as a computer readable storage medium, to store and/or access computer software including computer instructions. For example, computer programs or other instructions may be loaded into the computer system 300 such as through a removable storage device, for example, ZIP disks, portable flash drive, optical disk such as a CD or DVD or Blu-ray, Micro-Electro-Mechanical Systems (MEMS), nanotechnological apparatus, etc. Specifically, computer software including computer instructions may be transferred from the removable storage unit 314 or hard disc unit 312 to the secondary memory 310 or through the communication infrastructure 304 to the main memory 308 of the computer system 300.

Communication interface 316 allows software, instructions and data to be transferred between the computer system 300 and external devices or external networks. Software, instructions, and/or data transferred by the communication interface 316 are typically in the form of signals that may be electronic, electromagnetic, optical or other signals capable of being sent and received by the communication interface 316. Signals may be sent and received using wire or cable, fiber optics, a phone line, a cellular phone link, a Radio Frequency (RF) link, wireless link, or other communication channels.

Computer programs, when executed, enable the computer system 300, particularly the processor 306, to implement the methods of the invention according to computer software including instructions.

The computer system 300 described may perform any one of, or any combination of, the steps of any of the methods according to the invention. It is also contemplated that the methods according to the invention may be performed automatically.

The computer system 300 of FIG. 4 is provided only for purposes of illustration, such that the invention is not limited to this specific embodiment. It is appreciated that a person skilled in the relevant art knows how to program and implement the invention using any computer system.

The computer system 300 may be a handheld device and include any small-sized computer device including, for example, a personal digital assistant (PDA), smart hand-held computing device, cellular telephone, or a laptop or netbook computer, hand held console or MP3 player, tablet, or similar hand held computer device, such as an iPad®, iPad Touch® or iPhone®.

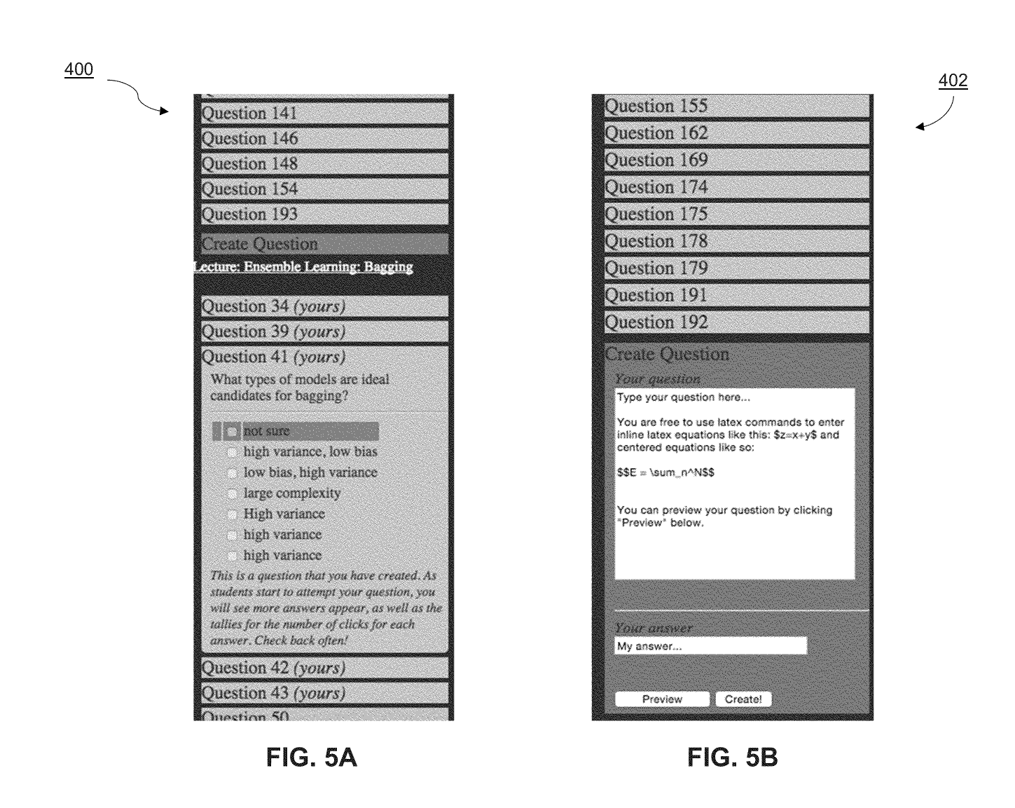

FIG. 5A and FIG. 5B illustrate a user interface display according to one embodiment of the invention. As shown in FIG. 5A, the invention displays a user interface 400 including a MCQ. The question is composed of potential answers derived from other participants. FIG. 5B illustrates a user interface display 402 including free-form input boxes in which the user creates a new question and creates what they believe is the correct answer. As shown in FIGS. 5A and 5B, questions and/or answers may be created by the user and further these questions and/or answers may be used as choices in a MCQ.

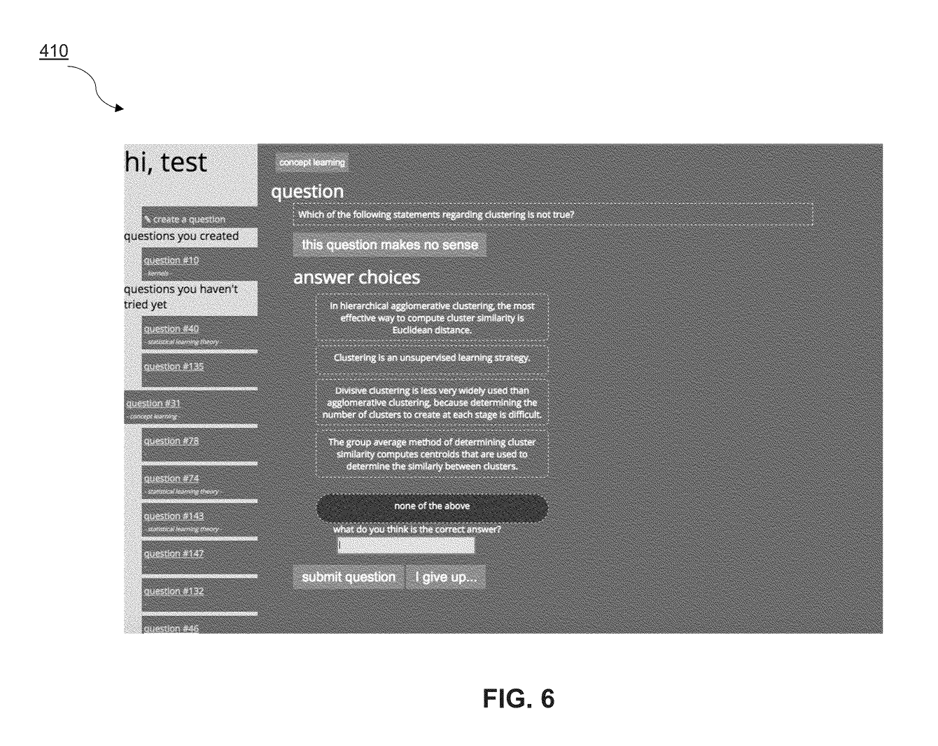

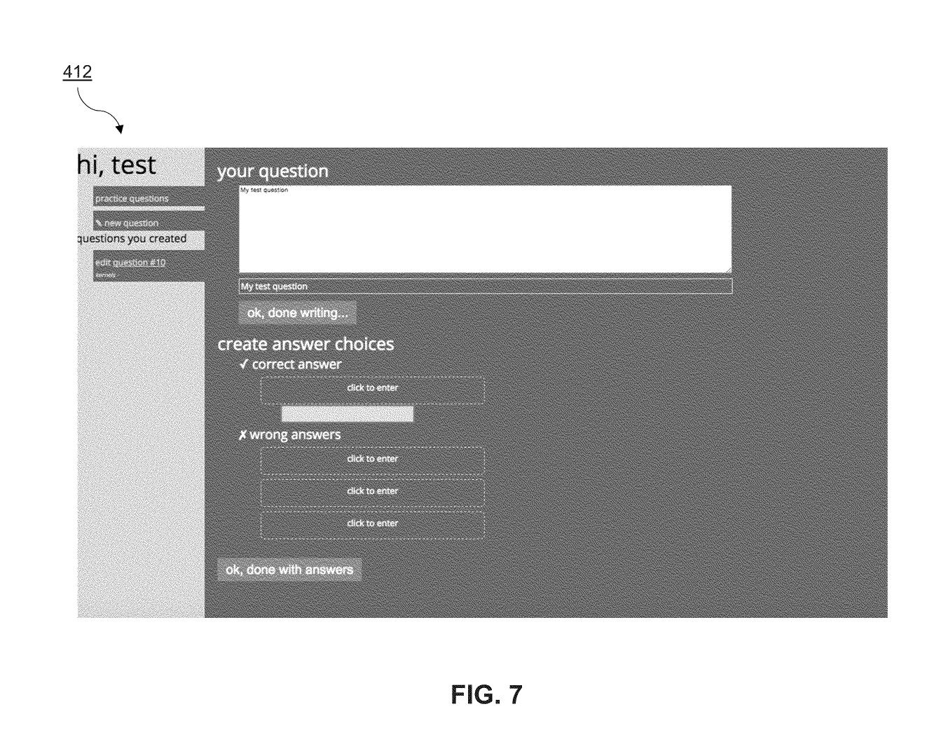

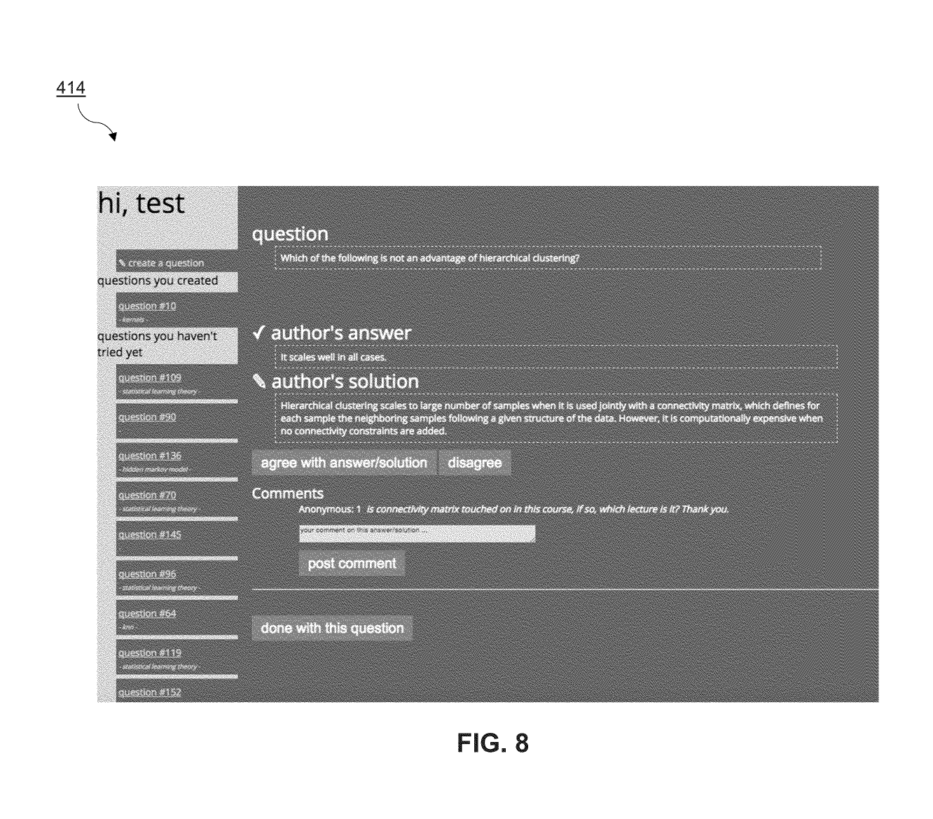

FIG. 6, FIG. 7, and FIG. 8 illustrate a user interface display according to another embodiment of the invention. According to this embodiment, the user creates the complete multiple choice question including for example the question, all answer options, or both. However, other users can create additional options in the process, if they believe that none of the options correctly answer the question. Furthermore, this embodiment of the invention allows for additional input from users such as whether the question possesses a high or low difficulty and/or the level of each answer's apparent correctness.

As shown in FIG. 6, the invention displays a user interface 410 including a MCQ in addition to a free-form input box in which the user creates a new answer they believe to be correct. For example, it the user chooses the “none of the above” option, he or she is offered an opportunity to provide an additional answer through the means of typing it in directly. Following the test, the user interface display 412 shown in FIG. 7 provides the user with an opportunity to contribute an additional question that may be used to improve the test. Once a user answers a question, a user interface display 414 is provided so that the user may visualize solutions and feedback comments provided by other users as shown in FIG. 8. It is contemplated that a score and rank (amongst all other users) may be provided to the user as feedback either immediately or with some delay.

From the potentially large set of user-provided “free-response” answers for any given question, the “most correct” and ‘least correct’ answers may be found. In addition, an optimal rank of the user among other participating users (who may not have seen an identical test) may be found from the user's selections and free-response contributions. Finally, an optimal subset of questions may be discovered (constrained by the total number of questions) including an optimal set of answers for each question that are considered most informative in inferring an updated ranking of the users.

While the disclosure is susceptible to various modifications and alternative forms, specific exemplary embodiments of the invention have been shown by way of example in the drawings and have been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

1. A method for generating optimal test content, the steps comprising of:
registering an initial user ability parameter value assigned to a user;
selecting test content;
displaying a user interface including the test content;
recording an answer from the set;
analyzing the recorded answer to determine a correctness parameter value and a user ability parameter value, wherein the correctness parameter is a proportion of the ability of the user and correctness of the recorded answer;
updating the user rank database with the user ability parameter value;
updating the answer database with the correctness parameter value; and
using the updated parameters to select new test content.

2. The method for generating optimal test content according to claim 1, wherein the proportion is defined by:
$$P ( {s}_{i} picks option j \vert {θ}_{i} , {\{ {β}_{j} \}}_{j ∈ Q} ) = \frac{exp ( {θ}_{i} {β}_{j} )}{{\sum }_{{β}_{{j}^{′}} ∈ Q} exp ( {θ}_{i} {β}_{{j}^{′}} )} \\ such that {β}_{j *} > {β}_{j} ∀ {β}_{j} ∈ Q ∖ {β}_{j *} \\ {θ}_{i} \geq 0 ∀ i$$
where sᵢ is user i with ability θᵢ, {βⱼ}_{j∈Q} is the set of option parameters of question Q, and βⱼ* is the correct answer choice.

3. The method for generating optimal test content according to claim 1, wherein the test content comprises a question and a set of answer choices.

4. The method for generating optimal test content according to claim 3, wherein the question is selected from a predetermined set in the question database.

5. The method for generating optimal test content according to claim 3, wherein the question is created by the user and contributed to the question database.

6. The method for generating optimal test content according to claim 1, wherein the answer is selected from a predetermined set in the answer database.

7. The method for generating optimal test content according to claim 1, wherein the answer is created by the user and contributed to the answer database.

8. The method for generating optimal test content according to claim 1, wherein the user ability parameter value equals 1 when the user has the greatest attainable ability and chooses a correct answer.

9. The method for generating optimal e content according to claim 1, wherein the selecting step further comprises:
registering a maximum number of answer choices for a set of answer choices for a question;
sampling the answer database for a plurality of answer sets constrained by the maximum number;
calculating a score for each answer set; and
selecting an answer set for the question.

10. The method for generating optimal test content according to claim 9, wherein the score is calculated according to:
$${maximize}_{\{ {x}_{i} {x}_{j} \}} \frac{{\sum }_{i , j} {x}_{i} {{x}_{j} ( {β}_{i} - {β}_{j} )}^{2} exp ( θ [ {β}_{i} + {β}_{j} ] )}{{\sum }_{i , j} {x}_{i} {x}_{j} exp ( θ [ {β}_{i} + {β}_{j} ] )}$$
$$subject to$$
$${x}_{i} ∈ \{ 0 , 1 \} , ∀ {x}_{i}$$
$$\sum {x}_{i} \leq K$$
where xᵢ and xⱼ are selection variables, θ is ability of the participant, β is the correctness parameter of each choice, and K is the maximum number of choices for a question Q.

11. The method for generating optimal test content according to claim 9, wherein sampling step uses a random sampling strategy that uniformly queries answers from the database at random.

12. The method for generating optimal test content according to claim 9, wherein sampling step uses an optimal sampling strategy that queries answers from the database according to the ability of one or more participants.
